(19) United States
(12) Patent Application Publication
(10) Pub. No.: US 2014/0274669 A1
(43) Pub. Date: Sep. 18, 2014

(54) Catalytic Article and Method for Preparing the Same

(71) Applicant: NATIONAL YUNLIN UNIVERSITY OF SCIENCE & TECHNOLOGY, Yunlin (TW)

(72) Inventors: Bo-Tau Liu, Yunlin (TW); Cheng-Hsien Hsieh, Yunlin (TW); De-Hua Wang, Yunlin (TW)

(73) Assignee: National Yunlin University of Science & Technology, Yunlin (TW)

(21) Appl. No.: 13/796,882

(22) Filed: Mar. 12, 2013

(51) Int. Cl. B01J 31/38

(52) U.S. Cl. CPC B01J 31/38
USPC 502/167; 502/150

(57) ABSTRACT

A catalytic article for destruction of a volatile organic compound includes a porous carrier body, a plurality of catalyst units formed on the carrier body and adapted for destruction of the volatile organic compound, and a plurality of trapping molecules bound to the carrier body. Each of the catalyst units is composed of one of a noble metal, a transition metal oxide, and the combination thereof. Each of the trapping molecules includes at least one functional group that is adapted for attracting or binding the volatile organic compound. A method for preparing the catalytic article is also disclosed.

### BACKGROUND OF THE INVENTION

1. Field of the Invention

This invention relates to a catalytic article, more particularly to a catalytic article for destruction of volatile organic compounds.

2. Description of the Related Art

Volatile organic compounds (VOCs), such as formaldehyde, exist in a variety of artificial products (like building or decorating materials and adhesives) and are released gradually into the air of an indoor living environment so as to cause damage to human body. A conventional method to remove the VOCs is to utilize a variety of adsorbent materials for adsorbing VOCs, or to utilize VOC-destructing materials for destructing or oxidizing VOCs directly into nontoxic substances.

Referring to FIG. 1, a conventional adsorbent material for volatile organic compounds 14 includes a carrier body 10 and a plurality of trapping units 12 bound on the carrier body 10 to adsorb the volatile organic compounds 14 via diffusion or forced convection. For example, Saeung et al. disclose an adsorbent material in Journal of Environmental Science 20 (2008), 379, and Afkhami et al. disclose another adsorbent material in Desalination 281 (2011), 151. Both of the adsorbent materials as set forth have respective trapping molecules grafted with amino groups and are capable of adsorbing formaldehyde from the air or water. However, after a period of working time, the aforesaid adsorbent materials reach a saturated state and need to be processed using a regenerating system so as to recover the adsorbent ability for the VOCs.

Referring to FIG. 2, a conventional VOC-destructing material for destruction of volatile organic compounds 24 is disclosed to include a carrier body 20 and a plurality of catalyst units 21 formed on the carrier body 21. Such catalyst units 21 contact the volatile organic compounds 24 via diffusion or forced convection and catalyze the oxidation of the volatile organic compounds 24 so as to decompose the volatile organic compounds 24 in the air or water. For example, U.S. Pat. No. 5,882,616 and U.S. Pat. No. 6,458,741B, as well as Taiwanese Patent No. 1293036 disclose several VOC-destructing materials of metal or metal oxide for destruction of the VOCs. However, these VOC-destructing materials have a relatively low destructing rate under low VOC concentration (such as an indoor living environment) and low temperature (such as room temperature), and are not able to remove the VOCs efficiently.

### SUMMARY OF THE INVENTION

Therefore, the object of the present invention is to provide a catalytic article that is capable of working under low VOC concentration and low temperature, and that is durable without aid from other regenerating systems.

According to one aspect of the present invention, a catalytic article includes:

a porous carrier body;

a plurality of catalyst units formed on the carrier body and adapted for destruction of the volatile organic compound, each of the catalyst units being composed of one of a noble metal, a transition metal oxide, and the combination thereof; and

a plurality of trapping molecules bound to the carrier body, each of the trapping molecules including at least one functional group that is adapted for attracting or binding the volatile organic compound.

According to another aspect of the present invention, a method for preparing the aforesaid catalytic article includes the following steps:

(a) providing a porous carrier body;

(b) forming a plurality of catalyst units on the carrier body, the catalyst unit being adapted for destruction of a volatile organic compound, each of the catalyst units being composed of one of a noble metal, a transition metal oxide, and the combination thereof; and

(c) forming a plurality of trapping molecules on the carrier body through covalent bonding to obtain the catalytic article, each of the trapping molecules having at least one functional group that is capable of attracting or binding the volatile organic compound.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic diagram illustrating a conventional adsorbent material structure for adsorbing volatile organic compounds (VOCs);

FIG. 2 is a schematic diagram illustrating a conventional VOC-destructing material structure for destruction of the volatile organic compounds;

FIG. 3 is a schematic diagram illustrating a preferred embodiment of a catalytic article according to the present invention; and

FIG. 4 is a graph illustrating formaldehyde conversion rates with respect to formaldehyde exposure time of an example of the preferred embodiment of this invention (represented as (a)) and a comparative example (represented as (b)).

### DETAILED DESCRIPTION OF THE PREFERRED EMBODIMENTS

Referring to FIG. 3, a preferred embodiment of a catalytic article according to the present invention includes a porous carrier body 30, a plurality of catalyst units 31, and a plurality of trapping molecules 32. The catalyst units 31 are formed on the carrier body 30 for destruction of volatile organic compounds and are composed of one of a noble metal, a transition metal oxide, and the combination thereof. The trapping molecules 32 are bound to the carrier body 30, and each of the trapping molecules 32 includes at least one functional group that is adapted for attracting or binding the volatile organic compounds.

Preferably, the noble metal is selected from the group consisting of platinum, gold, rhodium, palladium and combinations thereof. In an example of this invention, the noble metal is platinum.

Preferably, the transition metal oxide is selected from the group consisting of chromium oxide, cobalt oxide, copper oxide, silver oxide, and combinations thereof.

Preferably, the carrier body 30 is made of a material selected from the group consisting of titanium dioxide, silicon dioxide, aluminum (III) oxide, zirconium dioxide, zeolite, cerium dioxide, nickel dioxide, ferric oxide, ferriferous oxide, magnesium dioxide, and combinations thereof. In an example of this invention, the carrier body 32 is titanium dioxide.

Preferably, the functional group of each of the trapping molecules 32 is selected from the group consisting of an amino group, a hydroxyl group, a carboxyl group, a sulfate group, a sulfite group, a phosphate group and combinations thereof. In an example of this invention, the functional group of each of the trapping molecules 32 is an amino group.

Preferably, the trapping molecules 32 are distributed on a surface of the carrier body 30 at a density of 10⁻⁶ mole/m² to 10⁻⁴ mole/m².

Preferably, the ratio of the total weight of the catalyst units 31 and the carrier body 30 over the weight of the trapping molecules 32 is 1:1.

Preferably, the catalyst units 31 are present in an amount ranging from 0.01 wt % to 10 wt % based on the total weight of the catalytic article.

Accordingly, a method for preparing the catalytic article of the preferred embodiment includes the following steps:

(a) providing a porous carrier body 30;

(b) forming a plurality of catalyst units 31 on the carrier body 30, the catalyst units 31 being adapted for destruction of volatile organic compounds, each of the catalyst units 31 being composed of one of a noble metal, a transition metal oxide, and the combination thereof; and

(c) forming a plurality of trapping molecules 32 on the carrier body 30 through covalent bonding to obtain the catalytic article, each of the trapping molecules 32 having at least one functional group that is capable of attracting or binding the volatile organic compounds.

Preferably, the catalyst units 31 are formed on the carrier body 30 by an impregnation method, a co-precipitation method, a deposition-precipitation method, an ion-exchange method, or a chemical vapor deposition method.

### EXAMPLES

### Example 1

3 grams of titanium dioxide (as a carrier body, P-25 commercially available from Degussa) was placed into a flask, followed by adding 67.9 μL of 8 wt % chloroplatinic acid (H₂PtCl₆) aqueous solution (a precursor of Pt,) into the flask and drying under 80° C. to obtain a pre-processed titanium dioxide. Then, the pre-processed titanium dioxide was mixed with 11 mg of sodium borohydride (NaBH₄) and 3.9 ml of water for inducing a reduction reaction, and a primary product was obtained after 4 to 5 hours of reaction. The primary product was washed centrifugally within deionized water to remove unreacted sodium borohydride, followed by drying at 80° C. to obtain a titanium dioxide/platinum product (TiO₂/Pt, i.e., the carrier bodies with catalyst units).

Thereafter, 3 grams of TiO₂/Pt, 0.3 gram of (3-aminopropyl)triethoxysilane (abbreviated as APTES, the trapping molecules of the catalytic article), 15.6 ml of alcohol, and 4.5 ml of 0.1 N nitric acid were mixed together and heated under 70° C. to react for 3 hours to obtain a crude product. The crude product was washed centrifugally within alcohol to remove unreacted APTES, followed by drying at 80° C. to obtain the catalytic article of Example 1.

### Examples 2 to 6

The methods for preparing the catalytic articles of Examples 2 to 6 were similar to that of Example 1. The difference resides in that the amount of APTES used to prepare the catalytic article of each of Examples 2 to 6 was different from that of Example 1. The amount of APTES for the catalytic article of each of Examples 1 to 6 is listed in Table 1.

### Example 7

0.15 gram of the catalytic article of Example 3 was mixed with 0.15 gram of TiO₂ to obtain the catalytic article of Example 7.

### Comparative Example 1

The method for preparing the catalytic article of Comparative Example 1 was similar to that of Example 1. The difference resides in that APTES was not included in the catalytic article (i.e., only TiO₂/Pt).

### Comparative Example 2

The method for preparing the catalytic article of Comparative Example 2 was similar to that of Example 1. The difference resides in that APTES was reacted with TiO₂ instead of TiO₂/Pt to obtain an APTES modified TiO₂ product, followed by mixing 0.15 gram of the APTES modified TiO₂ product with 0.15 gram of TiO₂/Pt of Comparative Example 1 to obtain a catalytic article of Comparative Example 2.

### <Formaldehyde Conversion Test>

0.3 gram of the catalytic article of each of Examples 1 to 6 and Comparative Example 1 was embedded in a catalyst bed reactor, followed by feeding gaseous formaldehyde (10 ppm) flowing through the catalyst bed reactor with a gas hourly space velocity (GHSV) of 83000 h⁻¹ and detecting the concentration variation of the gaseous formaldehyde flowing in and out of the catalyst bed reactor via a formaldehyde detector (TRACENOSE, model#: IAQ-F100). A formaldehyde conversion rate of the catalytic article for each of Examples 1 to 6 and Comparative Example 1 was obtained by applying the following formula (I):

$$CR ( \% ) = \frac{Cin - Cout}{Cin} \times 100 \% \qquad ( I )$$

wherein CR (%) represents the formaldehyde conversion rate, Cin representing the concentration of gaseous formaldehyde flowing into the catalyst bed reactor, Cout representing the concentration of gaseous formaldehyde flowing out of the catalyst bed reactor. Results are listed in Table 1.

TABLE 1

| | | Stable Formaldehyde |
|---|---|---|
| Examples | APTES (g) | Conversion Rate (%) |
| Ex. 1 | 0.3 | 16.4 |
| Ex. 2 | 1.5 | 20.0 |
| Ex. 3 | 3.0 | 25.6 |
| Ex. 4 | 3.3 | 20.9 |
| Ex. 5 | 3.6 | 15.5 |
| Ex. 6 | 6.0 | 13.6 |
| C. E. 1 | 0 | 10.7 |

As shown in Table 1, in Comparative Example 1 in which APTES was not used, the Formaldehyde conversion rate is only 10.7%. With the increasing amount of APTES usage in the catalytic article, the Formaldehyde conversion rate increases until the ratio of the weight of APTES over the weight of TiO₂/Pt reaches 1:1 (i.e., Example 3, wherein the surface density of the amino groups of APTES distributed on the surface of TiO₂ was measured as 4.5×10⁻⁵ mol/m² via titration method). The increase of the Formaldehyde conversion rate may be attributed to the synergistic effect between APTES and Pt (the trapping molecules and the catalyst units), wherein APTES increases the local concentration of formaldehyde for Pt to increase the formaldehyde destructing rate. However, when the ratio of the weight of APTES over the weight of TiO₂/Pt increases from 1.1:1 to 2:1 (Examples 4 to 6), the excessive amount of APTES covers some of Pt particles on the surface of TiO₂, thereby resulting in decease of the formaldehyde conversion rate (from 20.9% to 13.6%).

### [Analysis of Effect of Locations of the APTES and Catalytic Units on Formaldehyde Conversion Rate]

The catalytic article of each of Example 7 and Comparative Example 2 was embedded into a catalyst bed reactor, followed by feeding gaseous formaldehyde (10 ppm) through the catalyst bed reactor with a GHSV of 83000 h⁻¹ and detecting the concentration variation of the gaseous formaldehyde while flowing in and out of the catalyst bed reactor via a formaldehyde detector (TRACENOSE, model#: IAQ-F100). The formaldehyde conversion rate of the catalytic article of each of Example 7 and Comparative Example 2 with respect to formaldehyde feeding time is plotted in FIG. 4.

As shown in FIG. 4, after feeding formaldehyde through the catalyst bed reactor for 120 minutes, the stable formaldehyde conversion rate of the catalyst article of Example 7 (FIG. 4(a)) and Comparative Example 2 (FIG. 4(b)) are 13.1% and 8.8% respectively, illustrating that the trapping molecules (APTES) and the catalyst units (Pt) need to be located on the same carrier bodies (TiO₂) for generating synergistic effect and increasing catalytic efficiency of the catalytic article (Example 7). When the trapping molecules (APTES) and the catalyst units (Pt) are located on different carrier bodies (TiO₂), there is weak or no synergistic effect occurred.

To sum up, the trapping molecules 32 of the catalytic article of the present invention increase the local concentration of the volatile organic compounds 34 around the catalyst units 31 of the catalytic article, thereby improving destructing rate of the volatile organic compounds 34 under room temperature and low VOC concentration. Moreover, since the volatile organic compounds 34 trapped by the trapping molecules 32 are decomposed by the catalyst units 31, the trapping molecules 32 could be regenerated, thereby maintaining high adsorbing efficiency of the trapping molecules 32 for a long period of working time.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A catalytic article for destruction of a volatile organic compound, said catalytic article comprising:
a porous carrier body;
a plurality of catalyst units formed on said carrier body and adapted for destruction of the volatile organic compound, each of said catalyst units being composed of one of a noble metal, a transition metal oxide, and the combination thereof; and
a plurality of trapping molecules bound to said carrier body, each of said trapping molecules including at least one functional group that is adapted for attracting or binding the volatile organic compound.

2. The catalytic article as claimed in claim 1, wherein said noble metal is selected from the group consisting of platinum, gold, rhodium, palladium and combinations thereof.

3. The catalytic article as claimed in claim 1, wherein said transition metal oxide is selected from the group consisting of chromium oxide, cobalt oxide, copper oxide, silver oxide and combinations thereof.

4. The catalytic article as claimed in claim 1, wherein said carrier body is made of a material selected from the group consisting of titanium dioxide, silicon dioxide, aluminum(III) oxide, zirconium dioxide, zeolite, cerium dioxide, nickel dioxide, ferric oxide, ferriferous oxide, magnesium dioxide, and combinations thereof.

5. The catalytic article as claimed in claim 1, wherein said functional group of each of said trapping molecules is selected from the group consisting of an amino group, a hydroxyl group, a carboxyl group, a sulfate group, a sulfite group, a phosphate group and combinations thereof.

6. The catalytic article as claimed in claim 5, wherein said functional group is an amino group.

7. The catalytic article as claimed in claim 1, wherein said trapping molecules are distributed on a surface of said carrier body at a density of 10⁻⁶ mole/m² to 10⁻⁴ mole/m².

8. The catalytic article as claimed in claim 1, wherein the ratio of the total weight of said catalyst units and said carrier body over the weight of said trapping molecules is 1:1.

9. The catalytic article as claimed in claim 1, wherein said catalyst units are present in an amount ranging from 0.01 wt % to 10 wt % based on the total weight of said catalytic article.

10. A method for preparing the catalytic article as claimed in claim 1, comprising the following steps:
(a) providing a porous carrier body;
(b) forming a plurality of catalyst units on the carrier body, the catalyst units being adapted for destruction of a volatile organic compound, each of the catalyst units being composed of one of a noble metal, a transition metal oxide, and the combination thereof; and
(c) forming a plurality of trapping molecules on the carrier body through covalent bonding to obtain the catalytic article, each of the trapping molecules having at least one functional group that is capable of attracting or binding the volatile organic compound.

11. The method as claimed in claim 10, wherein, in step (b), the catalyst units are formed on the carrier body by an impregnation method, a co-precipitation method, a deposition-precipitation method, an ion-exchange method, or a chemical vapor deposition method.

12. The method as claimed in claim 10, wherein, in step (c), the catalyst units are present in an amount ranging from 0.01 wt % to 10 wt % based on the total weight of the catalytic article.

13. The method as claimed in claim 10, wherein, in step (c), the ratio of the total weight of the catalyst units and the carrier body over the weight of the trapping molecules is 1:1.
